(19) United States
(12) Patent Application Publication
(10) Pub. No.: US 2019/0147506 A1
(43) Pub. Date: May 16, 2019

(54) SERVICE LOCATION MANAGEMENT SYSTEM

(71) Applicant: Capital One Services, LLC, McLean, VA (US)

(72) Inventors: Jeremy Phillips, Brooklyn, NY (US); Zhe Liu, McLean, VA (US); Jeremy Rephlo, Arlington, VA (US)

(21) Appl. No.: 15/811,424

(22) Filed: Nov. 13, 2017

(51) Int. Cl. G06Q 30/02; G06Q 30/06; H04W 4/04; H04L 29/08; G06Q 10/08; G06Q 90/00

(52) U.S. Cl. CPC G06Q 30/0281; G06Q 30/0613; G06Q 90/20; H04L 67/306; G06Q 10/087; H04W 4/04

(57) ABSTRACT

An example device may include one or more processors to receive information associated with one or more service resources that provide a service at a service location, at least one of the one or more service resources including a machine that is capable of automatically providing the service; monitor availability of the one or more service resources at the service location based on the information; provide status information, associated with the availability of the one or more service resources, to a user device to enable the user device to present the status information on a display, the status information indicating an availability for the user to receive the service at the service location based on a usage of the one or more service resources at the service location; receive a request for the service from the user device, the user device being associated with a user account registered with an entity that operates the service location; allocate a service resource of the one or more service resources at the service location to provide the service based on the request and a characteristic of the user account; detect an interaction between the user device and the allocated service resource at the service location; and automatically cause a transaction for the service to be processed using payment from a payment account associated with the user account based on detecting the interaction.

### BACKGROUND

Many business entities (e.g., financial institutions, retailers, restaurants, department stores, grocery stores, and/or the like) own and/or operate multiple service locations (which may be referred to as branches). In many instances, different service locations may offer and/or provide the same or different services. In some instances, some services may be provided by affiliates of the business entities (e.g., third party service providers, vendors, and/or the like).

### SUMMARY

According to some implementations, a device may include one or more processors to receive information associated with one or more service resources that provide a service at a service location, at least one of the one or more service resources including a machine that is capable of automatically providing the service; monitor availability of the one or more service resources at the service location based on the information; provide status information, associated with the availability of the one or more service resources, to a user device to enable the user device to present the status information on a display, the status information indicating an availability for the user to receive the service at the service location based on a usage of the one or more service resources at the service location; receive a request for the service from the user device, the user device being associated with a user account registered with an entity that operates the service location; allocate a service resource of the one or more service resources at the service location to provide the service based on the request and a characteristic of the user account; detect an interaction between the user device and the allocated service resource at the service location; and/or automatically cause a transaction for the service to be processed using payment from a payment account associated with the user account based on detecting the interaction.

According to some implementations, a non-transitory computer-readable medium may store one or more instructions that, when executed by one or more processors, may cause the one or more processors to: receive information associated with a service offered at a service location, the information indicating an availability of one or more transaction terminals associated with providing the service at the service location; monitor an availability of the service at the service location based on the information; provide status information associated with the availability of the service to a user device, the status information indicating the availability of the service at the service location based on a usage of the one or more transaction terminals associated with providing the service at the service location; receive a request for the service from the user device, the user device being associated with a user account registered with an entity that operates the service location; allocate a transaction terminal of the one or more transaction terminals at the service location to provide the service based on the request and the user account; determine that an interaction occurred between the user device and the transaction terminal at the service location; and/or cause a transaction for the service to be processed using payment from a payment account associated with the user account associated with the user device based on determining that the user device interacted with the transaction terminal.

According to some implementations, a method may include receiving, by a server device, first information associated with a first set of services that are offered at a first service location and second information associated with a second set of services that are offered at a second service location, the first service location and the second service location being operated by an entity that provides the first set of services and the second set of services; monitoring, by the server device, first availability of the first set of services based on the first information and second availability of the second set of services based on the second information; transmitting, from the server device to a user device, first status information associated with respective statuses of one or more of the first set of services and second status information associated with respective statuses of one or more of the second set of services, the first status information being indicative of the first availability based on a usage of transaction terminals at the first service location for providing the first set of services and the second status information being indicative of the second availability based on a usage of transaction terminals at the second service location for providing the second set of services; receiving, by the server device and from the user device, a request that a first service of the first set of services be provided at the first service location; allocating, by the server device, a first transaction terminal of the transaction terminals at the first service location to provide the first service based on the request; detecting, by the server device, an interaction between the user device and the first transaction terminal at the first service location; and/or processing, by the server device, a transaction for the first service using a user account associated with the user device based on detecting the interaction.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for managing services at service locations of an entity.

### DETAILED DESCRIPTION

The following detailed description of example implementations refers to the accompanying drawings. The same reference numbers in different drawings may identify the same or similar elements.

Service locations of a service provider (e.g., a business entity) may offer a variety of services that may vary from service location to service location. Accordingly, for a consumer of the entity to identify which services are offered at the service locations, the consumer may need to research (e.g., via a web search, contacting the individual service locations, etc.) which service locations provide a desired service. Furthermore, if the consumer wishes to receive such a service, the consumer may need to contact the service locations separately to make appointments for the service, and pay for the service via an in-person transaction.

Some implementations, described herein, provide a branch manager platform, for a service provider, that identifies or indicates offered services at service locations of the service provider, determines availabilities of the offered services, reserves resources (e.g., by scheduling appointments) that provide or facilitate providing the services, and/or processes a transaction for the service. Accordingly, consumers and/or user devices of consumers may utilize the branch manager platform to identify offered services, determine availabilities of the offered services, reserve resources for the offered services, and/or engage in transactions for the offered services.

According to some implementations, a branch manager platform may monitor availability of service resources (e.g., transaction terminals) that provide services at service locations of an entity, provide status information associated with the services resources to user devices, allocate resources based on requests for services from the user devices, and cause transactions to be processed based on interactions between the user devices and the service resources at the service locations. As a specific example, a branch manager platform may determine whether electric vehicle (EV) charging is available at service locations of an entity (which may not be considered a service provider of EV charging), monitor the usage of EV charging stations at the service locations of the entity, enable reservation of the EV charging stations (e.g., based on a membership status or other characteristics of an account of a consumer), and/or enable payment for EV charging (e.g., using payment from a payment account of the consumer that is associated with the entity).

As such, some implementations herein may conserve a variety of computing resources, network resources, and/or power resources for a consumer and/or business entity. For example, some implementations herein may avoid wasting computing resources used in searching for services (e.g., EV charging) at service locations, wasting computing resources to receive the services (e.g., by expending computing or power resources to arrive at a service location where EV charging is unavailable), wasting computing resources to process transactions (e.g., transactions involving external network communication with third party transaction service providers, such as card associations), and/or the like. Furthermore, some implementations herein may allow for controlled access to service resources (e.g., transaction terminals) at a service location, such that a user device may remotely control and/or reserve the service resource at the service location (e.g., by placing the service resource in a reservation mode).

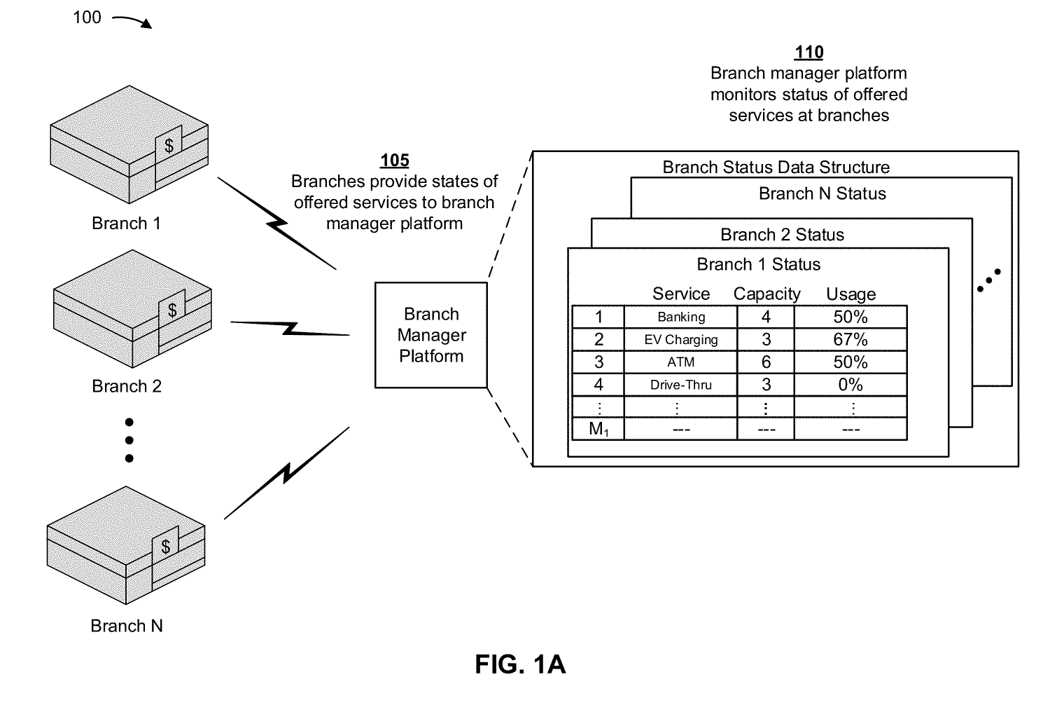

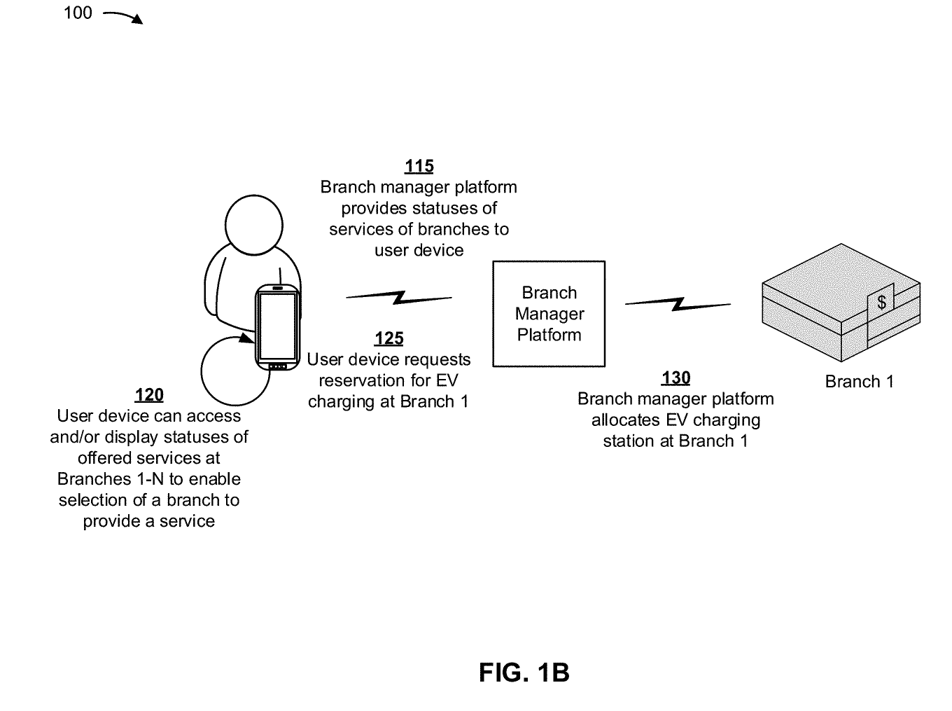

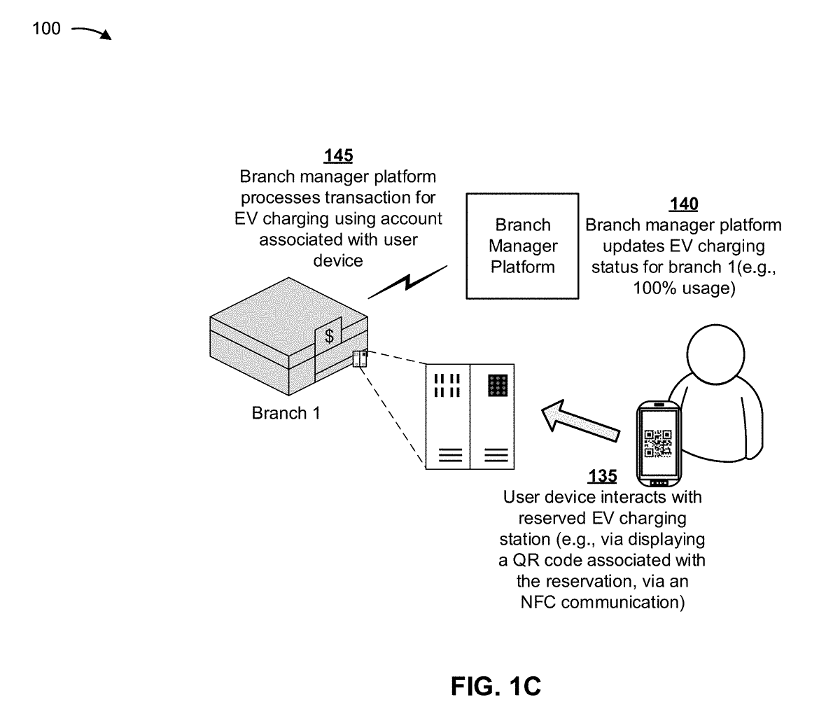

FIGS. 1A-1C are diagrams of an overview of an example implementation 100 described herein. In FIGS. 1A-1C, a branch manager platform monitors branches 1-N of an entity (where N corresponds to a number of branches managed by the entity), determines and provides availability of services at branches 1-N, and facilitates a transaction for a service of a branch (e.g., branch 1) according to some implementations described herein.

As shown in FIG. 1A, and by reference number 105, branches 1-N provide states of available services to the branch manager platform. For example, the branch manager platform may be in communication with one or more devices (e.g., transaction terminals) of the branches to determine the states of offered and/or available services at the branches. As shown by reference number 110, the branch manager platform monitors the status of the available services at the branches based on the states of the available services received from branches 1-N. For example, as shown in FIG. 1A, the branch manager platform may maintain a branch status data structure that includes, for each branch, service information, such as a type of service offered (e.g., banking, EV charging, automated teller machines (ATMs), drive-thru, and/or the like), a capacity or number of service resources (e.g., transaction terminals) at the service location, and/or a usage of the service resources.

As shown in FIG. 1B, and by reference number 115, the branch manager platform provides statuses of the services of the branches to a user device. For example, the branch manager platform may provide the statuses via an application associated with the entity that owns and/or operates the branches 1-N. As shown by reference number 120, the user device can access and/or display statuses of offered services at branches 1-N to enable selection of a branch to provide a service. As shown by reference number 125, assume that the user device requests a reservation for EV charging at branch 1. Accordingly, as shown by reference number 130, the branch manager platform may allocate an EV charging station at branch 1. For example, the branch manager platform may schedule a time period during which the EV may be used to access the EV charging station at branch 1 and/or the user device may be used to facilitate a transaction associated with charging the EV at branch 1. In some implementations, a specific EV charging station may be reserved at branch 1 during the time period or branch 1 may monitor the EV charging stations at branch 1 to ensure that at least one EV charging station remains available for the user device and/or EV to access during the reserved time period. For example, based on a request from a user device, the branch manager platform may place one or more EV charging stations in a reservation mode (e.g., until the user device arrives, until or during a requested time for performance of the service, and/or the like) to ensure that the EV charging station is available when a customer of the user device arrives at branch 1 to charge

As shown in FIG. 1C, and by reference number 135, the user device interacts with the reserved EV charging station (e.g., via displaying a token, such as a quick response (QR) code, associated with the reservation, via a near field communication (NFC) signal, and/or the like). As shown by reference number 140, the branch manager platform updates the EV charging service status for branch 1. For example, referring to the usage of FIG. 1A, the updated usage for EV charging service at branch 1 may now be identified as being at 100% usage. As shown by reference number 145, the branch manager platform processes a transaction for EV charging using an account associated with the user device. For example, based on the user device interacting with the EV charging station, the branch manager platform may cause a transaction to be processed using a payment account (e.g., a checking account) with the entity (e.g., a financial institution, such as a bank) that owns or operates branch 1.

Accordingly, the branch manager platform, in the example implementation 100 of FIGS. 1A-1C, enables a user device to access information indicating an offered service at a branch (e.g., one of branches 1-N) and the availability of the offered service at the branch, to request and/or reserve the offered service at the branch, and pay for and/or engage in a transaction for the service at the branch (e.g., using a user's payment account associated with an entity that owns or operates the branch). As such, the branch manager platform may conserve resources associated with a user device and/or resources of a branch (e.g., computing resources of the user device to determine service availability, power resources of an EV used to find an EV charging station, network resources for processing a transaction, and/or the like).

As indicated above, FIGS. 1A-1C are provided merely as an example. Other examples are possible and may differ from what was described with regard to FIGS. 1A-1C.

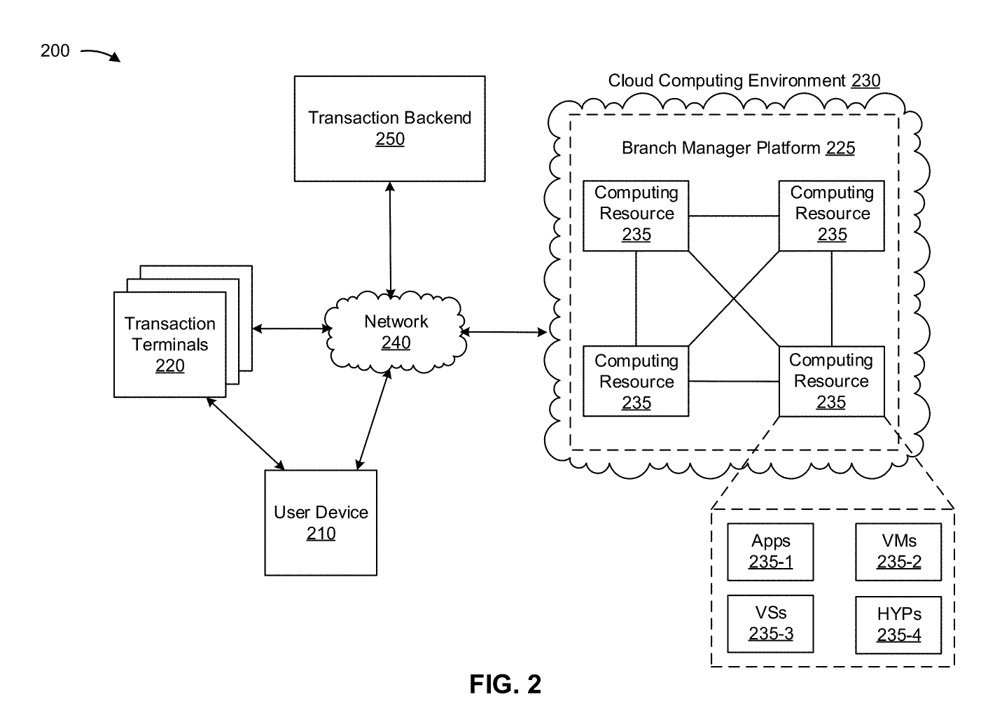

FIG. 2 is a diagram of an example environment 200 in which systems and/or methods, described herein, may be implemented. As shown in FIG. 2, environment 200 may include a user device 210, one or more transaction terminals 220, a branch manager platform 225 hosted within a cloud computing environment 230, a network 240 and a transaction backend 250. Devices of environment 200 may interconnect via wired connections, wireless connections, or a combination of wired and wireless connections.

User device 210 includes one or more devices capable of receiving, generating, storing, processing, and/or providing information associated with identifying services, reserving services, and/or engaging in transactions for services according to some implementations described herein. For example, user device 210 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Transaction terminal 220 includes one or more devices capable of receiving, generating, storing, processing, and/or providing information associated with facilitating a transaction (e.g., a point-of-sale (PoS) transaction). Transaction terminal 220 may be a service resource associated with providing a service (e.g., a machine that is capable of automatically providing the service) according to some implementation described herein. For example, transaction terminal 220 may include a communication device and/or computing device capable of receiving data from user device 210 and/or a transaction card and processing a transaction based on the data. In some implementations, transaction terminal 220 may include a desktop computer, a laptop computer, a tablet computer, a handheld computer, a mobile phone (e.g., a smart phone, a radiotelephone, and/or the like), a self-checkout station, a kiosk, and/or the like. Transaction terminal 220 may be owned and/or operated by one or more individuals or businesses engaged in a sale of goods or services (e.g., one or more merchants, vendors, service providers, and/or the like). In some implementations, after an interaction with user device 210, transaction terminal 220 may provide or indicate transaction information associated with a transaction to transaction backend 250 for processing of the transaction.

In some implementations, transaction terminal 220 includes one or more devices to facilitate processing a transaction via user device 210. For example, transaction terminal 220 may include a PoS terminal, a security access terminal, an automated teller machine (ATM) terminal, an EV charging station, a transaction terminal for a walk-up banking account service, a transaction terminal for a drive-thru banking account service, a transaction terminal for a walk-up ATM service, a transaction terminal for a drive-thru ATM service, a transaction terminal for a transaction card service, a transaction terminal for an investment banking service, a transaction terminal for a loan service, and/or the like. Transaction terminal 220 may include one or more input devices and/or output devices to facilitate obtaining transaction data or transaction information from user device 210 and/or a transaction card. Example input devices of transaction terminal 220 may include a number keypad, a touchscreen, a magnetic strip reader, a chip reader, a camera, a scanner (e.g., a barcode scanner, QR code scanner, and/or the like), and/or a radio frequency (RF) signal reader. Example output devices of transaction terminal 220 may include a display device, a speaker, a printer, and/or the like.

Branch manager platform 225 includes one or more devices (e.g., computing resources 235) capable of managing and/or integrating services at service locations of an entity (e.g., an individual or business involved in providing a service). For example, branch manager platform 225 may be capable of monitoring transaction terminals 220, reserving transaction terminals 220, and/or facilitating a transaction via user device 210 and/or transaction terminals 220. In some implementations, branch manager platform 225 may indicate or provide status information associated with services and/or transaction terminals 220 at service locations to user device 210.

Cloud computing environment 230 includes an environment that delivers computing as a service, whereby shared resources, services, etc. may be provided to user device 210, transaction terminals 220, and/or transaction backend 250. Cloud computing environment 230 includes an environment that hosts branch manager platform 225. Cloud computing environment 230 may provide computation, software, data access, storage, and/or other services that do not require end-user knowledge of a physical location and/or configuration of a system and/or a device that delivers the services. As shown, cloud computing environment 230 may include a group of computing resources 235 (which may be referred to herein individually as computing resource 235).

Notably, while implementations described herein describe branch manager platform 225 as being hosted in cloud computing environment 230, in some implementations, branch manager platform 225 may not be cloud-based (i.e., may be implemented outside of a cloud computing environment) or may be partially cloud-based.

Computing resource 235 includes one or more personal computers, workstation computers, server devices, or another type of computation and/or communication device. In some implementations, one or more computing resources 235 may host branch manager platform 225. The cloud resources may include compute instances executing in computing resource 235, storage devices provided in computing resource 235, data transfer devices provided by computing resource 235, etc. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, or the like.

Application 235-1 includes one or more software applications that may be provided to or accessed by user device 210. Application 235-1 may eliminate a need to install and execute the software applications on user device 210. For example, application 235-1 may include software associated with branch manager platform 225 and/or any other software capable of being provided via cloud computing environment 230. In some implementations, one application 235-1 may send/receive information to/from one or more other applications 235-1, via virtual machine 235-2.

Virtual machine 235-2 includes a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program, and may support a single process. In some implementations, virtual machine 235-2 may execute on behalf of a user (e.g., user device 210), and may manage infrastructure of cloud computing environment 230, such as data management, synchronization, or long-duration data transfers.

Virtualized storage 235-3 includes one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 provides hardware virtualization techniques that allow multiple operating systems (e.g., “guest operating systems”) to execute concurrently on a host computer, such as computing resource 235. Hypervisor 235-4 may present a virtual operating platform to the guest operating systems, and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

Transaction backend 250 includes one or more devices capable of authorizing and/or facilitating a transaction. For example, transaction backend 250 may include one or more servers and/or computers to store and/or provide information (e.g., authorizations, balances, transaction tokens, security information, account information, and/or the like) associated with processing a transaction via transaction terminal 220.

Transaction backend 250 may include one or more devices associated with financial institutions (e.g., banks, credit unions, and/or the like) and/or transaction card associations that authorize transactions and/or facilitate a transfer of funds or payments between an account of a user of user device 210 and/or a transaction card and an account of an individual or business of transaction terminal 220. For example, transaction backend 250 may include one or more devices of one or more issuing financial institutions associated with a user of user device 210, one or more devices of one or more acquiring financial institutions (or merchant banks) associated with transaction terminal 220, and/or one or more devices associated with one or more card associations (e.g., VISA®, MASTERCARD®, and/or the like) associated with accounts (e.g., credit accounts, debit accounts, and/or the like) associated with user device 210. Accordingly, in response to receiving account information associated with an account associated with a user of user device 210 (e.g., a checking account, a savings account, a membership account, a rewards account, a service-based credit account, and/or the like) from transaction terminal 220, various financial institutions and/or card associations of transaction backend 250 may communicate to authorize the transaction and/or transfer funds between accounts associated with the user of user device 210 and/or transaction terminal 220.

Transaction backend 250 may include one or more devices associated with a rewards program associated with an entity (e.g., a financial institution, a merchant, an EV charging service, and/or the like) providing the service via transaction terminal 220. For example, transaction backend 250 may authorize earning and/or redeeming of rewards (e.g., rewards points associated with receiving the service, cash rewards, client loyalty rewards associated with an entity associated with transaction terminal 220, and/or the like) based on a transaction processed by transaction terminal 220 via user device 210.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

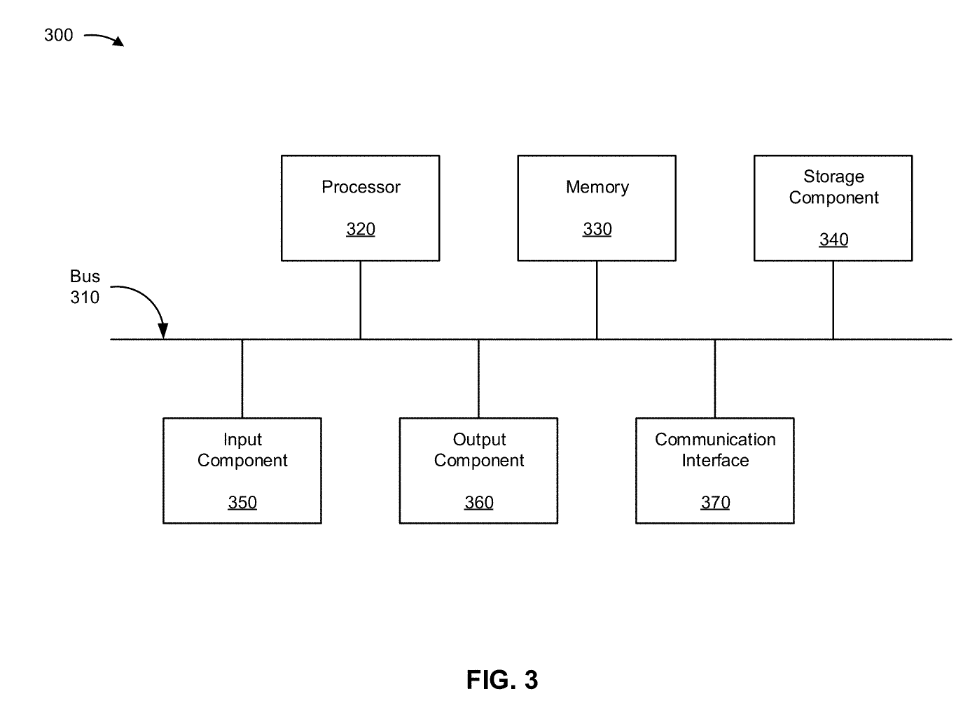

FIG. 3 is a diagram of example components of a device 300. Device 300 may correspond to user device 210, transaction terminal 220, branch manager platform 225, computing resource 235, and/or transaction backend 250. In some implementations, user device 210, transaction terminal 220, branch manager platform 225, computing resource 235, and/or transaction backend 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

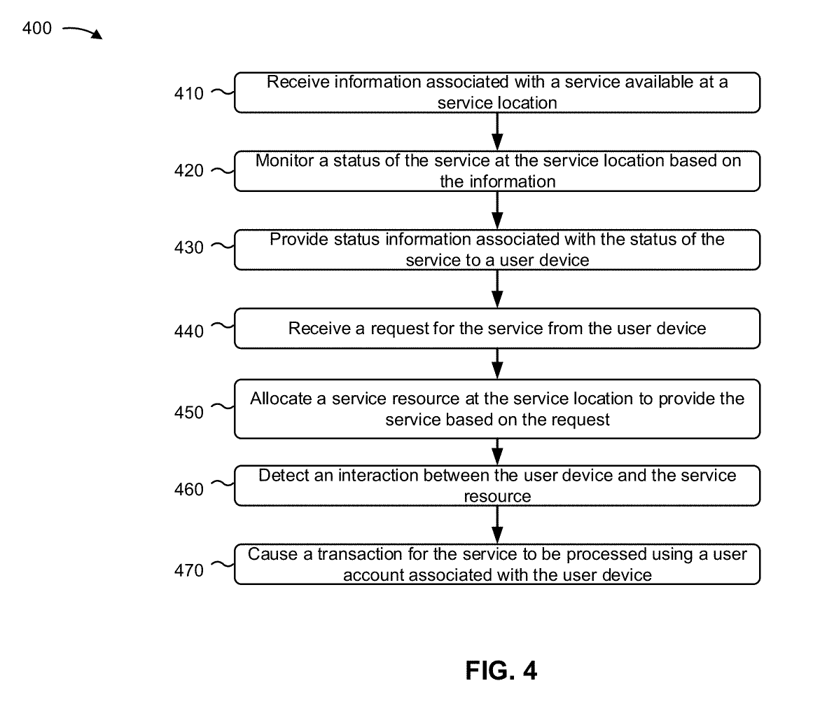

FIG. 4 is a flow chart of an example process 400 for managing services at service locations of an entity. In some implementations, one or more process blocks of FIG. 4 may be performed by branch manager platform 225. In some implementations, one or more process blocks of FIG. 4 may be performed by another device or a group of devices separate from or including branch manager platform 225, such as user device 210, transaction terminal 220, and/or transaction backend 250.

As shown in FIG. 4, process 400 may include receiving information associated with a service available at a service location (block 410). For example, branch manager platform 225 may receive information associated with a service and/or transaction terminal 220 that provides the service at a service location. In some implementations, branch manager platform 225 may receive the information based on being configured to communicate with transaction terminal 220, based on being configured to monitor transaction terminal 220, based on establishing a communication link with a communication interface at the service location, and/or the like.

According to some implementations, branch manager platform 225 may receive information associated with transaction terminal 220 that provides the service at the service location. In some implementations, the information may indicate an availability of transaction terminal 220 (e.g., whether transaction terminal 220 is operational, powered on, in use, and/or the like). In such cases, transaction terminal 220 may provide the information and/or branch manager platform 225 may obtain the information from transaction terminal 220.

The example service may be a walk-up banking account service (e.g., a face-to-face cashier service), a drive-thru banking account service (e.g., a cashier service accessible by vehicle), a walk-up ATM service, a drive-thru ATM service, a transaction card service (e.g., to request a new transaction card or replace a transaction card of an account, report theft or fraud associated with a transaction card, and/or the like), an investment banking service, or a loan service (e.g., a service that reviews loan applications and/or provides loans to loan applicants).

In some implementations, the service may be one of a plurality of services. In such cases, a plurality of different services may be offered at a service location. For example, a first service of the plurality of services may be an EV charging service and a second service of the plurality of services may be a walk-up banking account service. Additionally, or alternatively, branch manager platform 225 may receive information associated with a plurality of transaction terminals 220 and/or a plurality of service locations. For example, branch manager platform 225 may receive first information associated with a first set of services that are offered at a first service location and second information associated with a second set of services that are offered at a second service location.

In this way, branch manager platform 225 may receive information associated with a service and/or transaction terminal 220 for providing a service to enable branch manager platform 225 to monitor a status of the service and/or one or more service resources.

As further shown in FIG. 4, process 400 may include monitoring a status of the service at the service location based on the information (block 420). For example, branch manager platform 225 may monitor a status of the service. In some implementations, branch manager platform 225 may monitor the status of the service based on receiving the information associated with the service, based on being communicatively coupled with a transaction terminal 220 configured to provide the service, based on being configured to monitor transaction terminal 220, and/or the like.

According to some implementations, when monitoring the status of the service, branch manager platform 225 may monitor an availability of transaction terminal 220 that is to provide the service at the service location. For example, branch manager platform 225 may determine a usage of transaction terminal 220 at the service location based on a total number of transaction terminals 220 capable of providing the service at the service location and a number of transaction terminals 220 that are in use at the service location. In some implementations, branch manager platform 225 may monitor transaction terminals 220 that provide the service at the service location via the information associated with the service.

In some implementations, branch manager platform 225 may monitor multiple services and/or transaction terminals 220 at multiple service locations. Accordingly, branch manager platform 225 may monitor a first availability of a first set of services offered at a first service location and second availability of a second set of services offered at a second service location. As such, branch manager platform 225 may monitor transaction terminals 220 that provide the corresponding first set of services at the first service location and transaction terminals 220 that provide the corresponding second set of services at the second service location.

In some implementations, branch manager platform 225 may monitor a number of people or customers at a particular service location. For example, branch manager platform 225 may use cameras (and corresponding image analysis, biometric analysis, and/or the like) and/or sensors (e.g., temperature sensors, motion sensors, and/or the like) to determine how many customers are located within a service location. In some instances, branch manager platform 225 may monitor wireless signals from user device 210 (another other devices similar to user device 210) to determine a number of people at the service location. For example, the more unique signals detected from user devices, the more people can be presumed to be in the service location. In some implementations, branch manager platform 225 may utilize machine learning to estimate or determine a number of people in a branch based on analytics associated with images from cameras and/or sensor data from sensors located at the service location.

In this way, branch manager platform 225 may monitor a status and/or availability of a service and/or transaction terminal 220 that provides the service at a service location to permit branch manager platform 225 to provide status information indicating the status to user device 210.

As further shown in FIG. 4, process 400 may include providing status information associated with the status of the service to a user device (block 430). For example, branch manager platform 225 may provide status information associated with the service and/or an availability of the service to user device 210. In some implementations, branch manager platform 225 may provide the status information based on determining and/or identifying the status of the service at the service locations, a change in the status at the service location, generating the status information according to a status of the service at the service location, and/or the like.

According to some implementations, the status information may indicate an availability of the service at the service location based on a usage of transaction terminal 220 associated with providing the service at the service location. The example usage may be current usage (e.g., the usage at the moment user branch manager platform 225 is monitoring the service and/or transaction terminal 220) and/or historical usage of transaction terminal 220. Additionally, or alternatively, the status information may indicate an availability based on demand for the service (e.g., demand in a particular area, at a particular time, and/or the like). In such cases, the demand may be modeled from current usage and/or historical usage at particular locations and/or times (e.g., times of the day, times of the week, times of the year, etc.). In some implementations, branch manager platform 225 generates the status information. For example, branch manager platform 225 may generate the status information to indicate the availability of the service based on a number of transaction terminals 220 in use and a total number of transaction terminals 220 that provide the service.

In some implementations, branch manager platform 225 may provide, to user device 210, status information associated with multiple services and/or associated with multiple corresponding transaction terminals 220 at multiple service locations. For example, branch manager platform 225 may transmit first status information associated with a status of a first service of a first set of services offered at a first location and second status information associated with a status of a second service of a second set of services offered at a second service location. Accordingly, status information for multiple services and/or service locations may be provided to user device 210.

In this way, branch manager platform 225 may provide status information to a user device 210, which may request that a service be provided and/or reserved via branch manager platform 225.

As further shown in FIG. 4, process 400 may include receiving a request for the service from the user device (block 440). For example, branch manager platform 225 may receive a request for the service from user device 210. In some implementations, branch manager platform 225 may receive the request based on a user input to user device 210, based on the status information indicating an availability of transaction terminal 220, based on an event associated with an account of user device 210 (e.g., an EV passing a threshold level of available power, detecting potential fraud or actual fraud, detecting a low balance of a checking or savings account, etc.), detecting a parameter associated with a service (e.g., a stored power level of an EV) is below a threshold, and/or the like.

According to some implementations, user device 210 may be associated with a user account registered with an entity that operates the service location and/or that is associated with branch manager platform 225. For example, user device 210 may include an application that enables user device 210 to access and/or register a user account associated with the entity via branch manager platform 225. The example application may be hosted by branch manager platform 225 and/or maintained by the entity. In such instances, user device 210 and/or branch manager platform 225 may maintain the user account associated with the entity. In some implementations, branch manager platform 225 may receive a request from user device 210 to register the user account with the entity and branch manager platform 225 may register the user account with the entity based on a user input received via user device 210. In such cases, the user input may specify a membership type that may be used to allocate transaction terminal 220 and/or determine a transaction amount for the service. Accordingly, a user associated with user device 210 may be associated with the entity via a registered user account with the entity.

According to some implementations, branch manager platform 225 may indicate service locations that offer a particular service and the availability of the service. In some implementations, branch manager platform 225 may indicate a nearest storage location to user device 210 that is available to provide the service. For example, if a service is offered at a nearest service location, but all transaction terminals 220 that provide the service at the nearest service location are in use or are going to be in use at a requested time (i.e., usage is at 100% and the service is unavailable at the requested time), branch manager platform 225 may indicate the next nearest service location that is available to provide the service at the requested time.

In some implementations, the user account may include and/or identify a number of characteristics (which may correspond to the user or the user's status with the entity). For example, the characteristics may include membership information (e.g., a member identification, a member name, an indication of a relationship between the user of user device 210 and the entity, and/or the like) associated with the user account, a balance of funds in a payment account associated with the user account (e.g., which may indicate a tier or status of the user associated with user device 210), a membership type (e.g., a tier (e.g., top tier, low tier, etc.)) associated with the user of user device 210, types of accounts (e.g., checking, banking, investment banking, private banking, etc.) associated with user account, and/or the like. Accordingly, the characteristic of the user account may indicate a status or relationship between the user of user device 210 and the entity that operates branch manager platform 225 and/or the service locations.

According to some implementations, the request may be one of a plurality of requests for multiple services at one or more service locations. For example, the request may include a request that a first service of a first set of services be provided at a first service location and another request that a second service of the first set of services be provided at the first service location. In such cases, the first service and the second service may be provided by a first transaction terminal 220 and a second transaction terminal 220 respectively. Furthermore, the first transaction terminal 220 may be operated by a first entity and the second transaction terminal 220 may be operated by another entity that is different than the first entity. For example, a first entity (e.g., an EV charging service provider) may operating an EV charging station (the first transaction terminal) at the service location and a second entity (e.g., a financial institution, such as a bank) may operate an ATM terminal at the service location (e.g., a branch of the financial institution of the bank). In some implementations, multiple requests may be received such that branch manager platform 225 receives a request that a first service of a first set of services be provided at a first service location and another request that a second service of a second set of services be provided at a second location. In such cases, the second service may not be included in the first set of services available at the first service location (and vice versa).

In some implementations, the request may be any data (e.g., a message, an email, a text, an image, and/or the like) indicating a particular type of service to be provided at a particular service location. Accordingly, based on the specific type of service to be provided and/or service location where the service is to be provided, branch manager platform 225 may identify a corresponding transaction terminal 220 that is available to provide the service.

In this way, branch manager platform 225 may receive a request for a service from user device 210 that permits branch manager platform 225 to allocate transaction terminal 220 to provide the service.

As further shown in FIG. 4, process 400 may include allocating a service resource at the service location to provide the service based on the request (block 450). For example, branch manager platform 225 may allocate transaction terminal 220 at the service location to provide the service based on the request. In some implementations, branch manager platform 225 may allocate transaction terminal 220 based on receiving the request for service from user device 210 and/or based on determining a characteristics of user device 210 and/or a characteristic of a user account associated with user device 210.

Branch manager platform 225 may allocate transaction terminal 220 to provide a service by reserving or scheduling a time period for transaction terminal 220 to provide the service. For example, branch manager platform 225 may identify a schedule associated with transaction terminal 220 that indicates when transaction terminal 220 is to be in use to provide a service. For example, the schedule may indicate when transaction terminal 220 is available to provide a service, is reserved to provide a service, scheduled to be unavailable (e.g., due to hours of operation for the service location and/or transaction terminal 220), and/or the like. Accordingly, branch manager platform 225 may utilize the schedule when allocating transaction terminal 220 to provide a service by reserving time periods in the schedule when transaction terminal 220 is available to provide the service and/or when user device 210 is available to receive the service (e.g., based on a calendar or schedule of user device 210).

According to some implementations, branch manager platform 225 may determine a characteristic of a user account associated with user device 210 and an entity of the service location. For example, branch manager platform 225 may determine a priority associated with providing the service based on the characteristic and allocate transaction terminal 220 based on the priority associated with providing the service. For example, branch manager platform 225 may determine membership information (e.g., whether user device 210 is associated with an entity of transaction terminal 220), payment account information (e.g., information indicating a balance of funds in the payment account), and/or a membership type (e.g., a top tier membership, a low-tier membership, and/or the like) associated with an account of user device 210, and allocate transaction terminal 220 based on the membership information, payment account information, and/or membership type. Accordingly, the characteristic of the user account may be used to allocate transaction terminal 220 to provide a service based on the request of user device 210.

In some implementations, when branch manager platform 225 determines the characteristic indicates that user device 210 is associated with a member of the entity, then user device 210 may receive priority for reserving transaction terminal 220 over other user devices 210 that are not associated with members of the entity or have a lower status (based on membership type) with the entity. In some implementations, transaction terminal 220 may only be reserved to provide a service when user device 210 is associated with a user account of the entity.

According to some implementations, branch manager platform 225 may allocate transaction terminal 220 based on identifying a particular time in the request for service received from user device 210. For example, branch manager platform 225 may determine an expected availability of the service at the service location at the requested time based on a usage (e.g., current usage and/or historical usage) of transaction terminals 220 that provide the service and allocate transaction terminal 220 at the service location based on the expected availability. In some implementations, branch manager platform 225 may utilize machine learning for allocating transaction terminal 220 to provide a service. For example, machine learning may be used to predict an availability of a transaction terminal based on an expected demand (e.g., either current demand, historical demand, and/or the like). In such cases, branch manager platform 225 may utilize machine learning to update a model corresponding to predicting the availability of transaction terminal 220.

Branch manager platform 225 may allocate transaction terminal 220 to provide a service by reserving or scheduling a time period for transaction terminal 220 to provide the service. For example, branch manager platform 225 may send instructions or a message to place transaction terminal 220 in a reservation mode during a particular time associated with performance of the service (e.g., a time requested in the request). Accordingly, when in reservation mode, transaction terminal 220 may only be activated or enabled to provide a service via an interaction with user device 210.

In some implementations, branch manager platform 225, when allocating multiple transaction terminals 220 for multiple services may determine a time period during which a first transaction terminal 220 and a second transaction terminal are both available based on availability of the first transaction terminal 220 and the second transaction terminal 220. In such a case, the first transaction terminal 220 and the second transaction terminal 220 may be reserved at the same time. For example, an EV charging station and a transaction terminal for walk-up banking account service may be reserved during a same time period (e.g., so that a user's vehicle may charge while receiving the banking account service).

In this way, branch manager platform 225 may allocate transaction terminal 220 to provide a service (e.g., during a period of time) to enable or permit user device 210 to interact with the transaction terminal 220 to enable performance of the service.

As further shown in FIG. 4, process 400 may include detecting an interaction between the user device and the service resource (block 460). For example, branch manager platform 225 may detect an interaction between transaction terminal 220 and user device 210. In some implementations, branch manager platform 225 may detect the interaction based on monitoring and/or determining that transaction terminal 220 is to interact with user device 210 during a particular time period (e.g. a time period requested by user device 210 and/or allocated by branch manager platform 225), but determining that an interface of transaction terminal 220 was accessed by user device 210, and/or that an interface of transaction terminal 220 was utilized to interact with user device 210.

In some implementations, branch manager platform 225 may detect the interaction by monitoring transaction terminal 220 to determine that the interaction occurred during a time period associated with providing the service. According to some implementations, the interaction may include a NFC interaction between user device 210 and the transaction terminal 220, transaction terminal 220 capturing an image on a display of user device 210 (e.g., to scan a barcode or QR code), transaction terminal 220 receiving verification information associated with user device 210 receiving or reserving the service, and/or the like.

In some implementations, the verification information may include a transaction identifier or reservation identifier sent to user device 210 and/or entered on an input device of transaction terminal 220. Additionally, or alternatively, the verification information may include biometric information associated with a user of user device 210. For example, the verification information may include a biometric signature, such as a fingerprint signature, a facial scan signature, a retina scan signature, a gait signature, and/or the like associated with the user. In such cases, based on the interaction of providing the verification information, transaction terminal 220 may perform a user identification verification process to verify the identity of the user. For example, transaction terminal 220 may perform a biometric scan (e.g., capture a fingerprint, capture an image of a user's face, and/or the like) of a user that caused the interaction between user device 210 and transaction terminal 220. Transaction terminal 220 may authorize the service to be provided based on whether transaction terminal 220 is able to match the biometrics of the user with a biometric token from user device 210.

In this way, branch manager platform 225 may detect an interaction between user device 210 and transaction terminal 220 to permit branch manager platform 225 to facilitate processing a transaction for the service.

As further shown in FIG. 4, process 400 may include causing a transaction for the service to be processed using a user account associated with the user device (block 470). For example, branch manager platform 225 may cause a transaction for the service to be processed using user device 210 (and/or the user account associated with user device 210) and transaction terminal 220. In some implementations, branch manager platform 225 may cause the transaction for the service to be processed based on detecting the interaction between user device 210 and transaction terminal 220.

In some implementations, branch manager platform 225 may cause the transaction to be processed using payment from a payment account associated with a user account and the entity. Additionally or alternatively, branch manager platform 225 may cause the transaction to be processed by causing a transfer of funds from the payment account associated with the user account of user device 210 to an account of the entity that operates the service location and/or that operates transaction terminal 220. For example, branch manager platform 225 may instruct transaction backend 250 to transfer funds from the payment account to the account of the entity.

In some implementations, branch manager platform 225 may identify a characteristic of the user account (e.g., membership information, account balance information, membership type information) and determine a transaction amount to be charged based on the characteristic of the user account. For example, if the user account indicates that a user associated with user device 210 is a top tier member, then branch manager platform 225 may determine transaction amount to be discounted (e.g., based on an amount, a percentage of a particular rate (e.g. 0%, 50%, 75%, etc.) relative to a non-top tier member or non-member. In such cases, branch manager platform 225 may cause withdrawal of funds from the payment account based on the determined transaction amount. In some implementations, the payment account (e.g., a checking account, a savings account, and/or the like) may be managed by an entity (e.g. a financial institution) that operates the service location (e.g., a branch of the financial institution).

In this way, branch manager platform 225 may cause a transaction to be processed for performance of the service based on an interaction between user device 210 and transaction terminal 220.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Accordingly, branch manager platform 225 may be integrated for use with user device 210 and/or transaction terminal 220 to indicate an offered service at a service location, determine availability of the offered service, reserve transaction terminal 220 (e.g., by scheduling time period for providing the service based on an interaction with user device 210) to provide or facilitate providing the service, and/or process a transaction for the service. As such, some implementations described herein may conserve a variety of computing resources (e.g., resources that may be used to search for services), network resources (e.g., resources to facilitate processing transactions with third party financial institutions), and/or power resources (e.g., resources used by an EV and/or user device 210 to identify an available EV charging station, resources to process transactions with third party financial institutions, resources to power an unused transaction terminal 220, and/or the like).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend from only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
one or more memories; and
one or more processors, communicatively coupled to the one or more memories, to:
receive information associated with one or more service resources that provide a first service and a second service at a plurality of service locations,
at least one of the one or more service resources including a machine that is capable of automatically providing the first service,
the first service being different than the second service;
monitor availability of the one or more service resources at the plurality of service locations based on the information;
provide status information, associated with the availability of the one or more service resources, to a user device to enable the user device to present the status information on a display,
the status information indicating an availability for the user device to receive the first service and the second service at the plurality of service locations based on a usage of the one or more service resources at the plurality of service locations,
the status information indicating, for each service location of the plurality of service locations, a list of services offered at each service location;
predict an availability of the one or more service resources at the plurality of service locations to provide the first service and the second service,
the availability being predicted based upon demand,
the demand being modeled based upon current usage and historical usage, and
a model for the demand being updated based upon machine learning;
receive a request for the first service and the second service at a particular service location from the user device,
the user device being associated with a user account registered with an entity that operates the particular service location;
allocate a first service resource and a second service resource of the one or more service resources at the particular service location to provide the first service and second service based on:
the request,
a characteristic of the user account, and
the predicted availability,
the first service resource and the second service resource being allocated based upon determining a time period which the first service resource and the second service resource are both predicted to be available;
provide instructions to place a first machine associated with the first service resource and a second machine associated with the second service resource in a reservation mode during the time period which the first service resource and the second service resource are both predicted to be available,
the reservation mode allowing the first machine associated with the first service resource and the second machine associated with the second service resource only to be activated or enabled during the time period via an interaction with the user device;
detect the interaction between the user device and the first service resource at the particular service location,
the interaction causing the first machine associated with the first service resource to be taken out of the reservation mode and activated or enabled; and
automatically cause a transaction for the first service to be processed using payment from a payment account associated with the user account based on detecting the interaction.

2. The device of claim 1, where the one or more processors, when monitoring the availability of the one or more service resources at the plurality of service locations, are to:
determine the usage of the one or more service resources at the particular service location based on a total number of the one or more service resources for providing the first service at the particular service location and a number of the one or more service resources that are in use to provide the first service; and
generate the status information based on the usage of the one or more service resources at the particular service location.

3. The device of claim 1, where the one or more processors, when allocating the first service resource, are to:
determine a priority associated with providing the first service based on the characteristic of the user account; and
allocate the first service resource based on the priority associated with providing the first service.

4. The device of claim 3, where the characteristic of the user account includes at least one of:
membership information associated with the user account,
a balance of funds in the payment account associated with the user account, or
a membership type of the user account associated with the entity that operates the particular service location.

5. The device of claim 1, where the one or more processors, when causing the transaction to be processed, are to:
cause a transfer of funds from the payment account associated with the user account to an account of the entity that operates the particular service location.

6. The device of claim 1, where the one or more processors, when causing the transaction to be processed, are to:
identify the characteristic of the user account;
determine a transaction amount to be charged based on the characteristic of the user account; and
cause withdrawal of funds from the payment account based on the transaction amount,
the payment account being managed by the entity that operates the particular service location.

7. The device of claim 1, where the first service is an electric vehicle (EV) charging service and the second service includes at least one of:
a walk-up banking account service,
a drive-thru banking account service,
a walk-up automated teller machine (ATM) service,
a drive-thru ATM service,
a transaction card service,
an investment banking service, or
a loan service.

8. A non-transitory computer-readable medium storing instructions, the instructions comprising:
one or more instructions that, when executed by one or more processors, cause the one or more processors to:
receive information associated with a first service and a second service offered at a plurality of service locations,
the information indicating an availability of one or more transaction terminals associated with providing the first service and the second service at the plurality of service locations;
monitor an availability of the first service and the second service at the plurality of service locations based on the information;
provide status information associated with the availability of the first service and the second service to a user device,
the status information indicating the availability of the first service and the second service at the plurality of service locations based on a usage of the one or more transaction terminals associated with providing the first service and the second service at the plurality of service locations,
the status information indicating, for each service location of the plurality of service locations, a list of services offered at each service location;
predict an availability of the one or more transaction terminals at the plurality of service locations to provide the first service and the second service,
the availability being predicted based upon demand,
the demand being modeled based upon current usage and historical usage, and
a model for the demand being updated based upon machine learning;
receive a request for the first service and the second service at a particular service location from the user device,
the user device being associated with a user account registered with an entity that operates the particular service location;
allocate a first transaction terminal and a second transaction terminal of the one or more transaction terminals at the particular service location to provide the first service and the second service based on the request and the user account,
the first transaction terminal and the second transaction terminal being allocated based upon determining a time period which the first transaction terminal and the second transaction terminal are both predicted to be available;
provide instructions to place the first transaction terminal and the second transaction terminal in a reservation mode during the time period which the first service and the second service are both predicted to be available,
the reservation mode allowing the first transaction terminal and the second transaction terminal only to be activated or enabled during the time period via an interaction with the user device;
determine that the interaction occurred between the user device and the first transaction terminal at the particular service location,
the interaction causing the first transaction terminal to be taken out of the reservation mode and activated or enabled; and
cause a transaction for the first service to be processed using payment from a payment account associated with the user account associated with the user device based on determining that the user device interacted with the first transaction terminal.

9. The non-transitory computer-readable medium of claim 8, where the one or more instructions, when executed by the one or more processors, further cause the one or more processors to:
determine the usage of the one or more transaction terminals at the particular service location based on a total number of the one or more transaction terminals for providing the first service at the particular service location and a number of the one or more transaction terminals that are in use to provide the first service.

10. The non-transitory computer-readable medium of claim 8, where the request for the first service includes a requested time for providing the first service, and
where the one or more instructions, that cause the one or more processors to allocate the first transaction terminal at the particular service location, cause the one or more processors to:
determine an expected availability of the first service at the particular service location at the requested time based on the usage of the one or more transaction terminals;
determine a priority associated with the user account; and
allocate the first transaction terminal at the particular service location based on the expected availability and the priority associated with the user account.

11. The non-transitory computer-readable medium of claim 8, where the one or more instructions, that cause the one or more processors to monitor the availability of the first service at the particular service location, are to:
monitor the one or more transaction terminals that provide the first service at the particular service location via the information associated with the first service;
determine a number of the one or more transaction terminals in use; and
generate the status information to indicate the availability of the first service based on the number of the one or more transaction terminals in use and a total number of the one or more transaction terminals that provide the first service.

12. The non-transitory computer-readable medium of claim 8, where the one or more instructions, that cause the one or more processors to determine that the interaction occurred between the user device and the first transaction terminal, are to:
monitor the first transaction terminal to determine that the interaction occurred during the time period associated with providing the first service,
where the interaction includes at least one of:
a near field communication (NFC) between the user device and the first transaction terminal,
the first transaction terminal capturing an image of a display of the user device, or
the first transaction terminal receiving verification information associated with the user device.

13. The non-transitory computer-readable medium of claim 8, where the one or more instructions, when executed by the one or more processors, further cause the one or more processors to:
receive a request to register the user account with the entity; and
register the user account with the entity based on a user input received via the user device,
the user input including a membership type that is used to allocate the first transaction terminal.

14. The non-transitory computer-readable medium of claim 8, where the first transaction terminal comprises an electric vehicle (EV) charging station and the entity comprises a financial institution associated with the payment account.

15. A method, comprising:
receiving, by a server device, first information associated with a first set of services that are offered at a first service location and second information associated with a second set of services that are offered at a second service location,
the first service location and the second service location being operated by an entity that provides the first set of services and the second set of services;
monitoring, by the server device, first availability of the first set of services based on the first information and second availability of the second set of services based on the second information;
transmitting, from the server device to a user device, first status information associated with respective statuses of one or more of the first set of services and second status information associated with respective statuses of one or more of the second set of services,
the first status information being indicative of the first availability based on a usage of transaction terminals at the first service location for providing the first set of services and the second status information being indicative of the second availability based on a usage of transaction terminals at the second service location for providing the second set of services;
predicting, by the server device, an availability of the first set of services at the first service location and the second set of services at the second service location,
the availability being predicted based upon demand,
the demand being modeled based upon current usage and historical usage, and
a model of the demand being updated based upon machine learning;
receiving, by the server device and from the user device, a request that a first service of the first set of services and a second service of the first set of services be provided at the first service location,
the first service being different than the second service;
allocating, by the server device, a first transaction terminal and a second transaction terminal of the transaction terminals at the first service location to provide the first service and the second service based on the request,
the first transaction terminal and the second transaction terminal being allocated based upon determining a time period which the first transaction terminal and the second transaction terminal are both predicted to be available;
providing, by the server device, instructions to place the first transaction terminal and the second transaction terminal in a reservation mode during the time period which the first service and the second service are both predicted to be available,
the reservation mode allowing the first transaction terminal and the second transaction terminal only to be activated or enabled during the time period via an interaction with the user device;
detecting, by the server device, the interaction between the user device and the first transaction terminal at the first service location,
the interaction causing the first transaction terminal to be taken out of the reservation mode and activated or enabled; and
processing, by the server device, a transaction for the first service using a user account associated with the user device based on detecting the interaction.

16. The method of claim 15, further comprising:
detecting an interaction between the user device and the second transaction terminal at the first service location; and
causing a transaction for the second service to be processed using the user account associated with the user device.

17. The method of claim 16, where the first transaction terminal and the second transaction terminal are operated by different entities.

18. The method of claim 16, further comprising:
determining the time period during which the first transaction terminal and the second transaction terminal are both available based on the first availability,
where allocating the first transaction terminal at the first service location comprises allocating the first transaction terminal for the first service to be provided during the time period, and
where allocating the second transaction terminal at the first service location comprises allocating the second transaction terminal for the second service to be provided during the time period.

19. The method of claim 15, further comprising:
receiving, from the user device, another request that an additional service of the second set of services be provided at the second service location;
allocating an additional transaction terminal at the second service location to provide the additional service based on the other request;
detecting an interaction between the user device and the additional transaction terminal at the second service location; and
causing a transaction for the additional service to be processed, based on detecting the interaction between the user device and the additional transaction terminal, using the user account associated with the user device.

20. The method of claim 19, where the additional service is not included in the first set of services available at the first service location.
